(19) United States
(12) Patent Application Publication
(10) Pub. No.: US 2025/0324355 A1
(43) Pub. Date: Oct. 16, 2025

(54) COMMUNICATION MANAGEMENT SYSTEM, COMMUNICATION MANAGEMENT METHOD, MOVABLE OBJECT, AND MANAGEMENT APPARATUS

(71) Applicant: Sony Group Corporation, Tokyo (JP)

(72) Inventor: Hideyuki SUZUKI, Tokyo (JP)

(73) Assignee: Sony Group Corporation, Tokyo (JP)

(21) Appl. No.: 18/868,796

(22) PCT Filed: May 16, 2023
(86) PCT No.: PCT/JP2023/018216

§ 371 Date: Nov. 25, 2024

(30) Foreign Application Priority Data
May 30, 2022 (JP) 2022-087420

(51) Int. Cl. H04W 48/16; H04W 72/12; H04W 72/566

(52) U.S. Cl. CPC H04W 48/16; H04W 72/12; H04W 72/566

(57) ABSTRACT

The present technology relates to a communication management system, a communication management method, a movable object, and a management apparatus that allow efficient transmission of three-dimensional configuration view data from a movable object. A plan generating unit that generates, on the basis of a state of a transmission channel on a movement route of a movable object and a priority of three-dimensional configuration view data to be used for generating a three-dimensional configuration view, a plan of a transmission timing that is a spatial timing at which the movable object transmits the three-dimensional configuration view data on the transmission channel. The present technology can be applied to, for example, a communication management system that updates the three-dimensional configuration view by using the three-dimensional configuration view data transmitted from the movable object.

### TECHNICAL FIELD

The present technology relates to a communication management system, a communication management method, a movable object, and a management apparatus, and, in particular, relates to a communication management system, a communication management method, a movable object, and a management apparatus that allow efficient transmission of three-dimensional configuration view data from a movable object.

### BACKGROUND ART

It is essential to build a fresh and highly accurate three-dimensional configuration view for example for autonomous control or remote control of a movable object such as an automobile or drone or measurement analysis utilizing sensing data collected by the movable object. For building such three-dimensional configuration views, it is necessary to frequently acquire highly accurate three-dimensional configuration view data required for generating a three-dimensional configuration view and update the three-dimensional configuration view. Thus, it is conceivable that the movable object acquires highly accurate three-dimensional configuration view data while moving and transmits the three-dimensional configuration view data to a device that updates the three-dimensional configuration view for updating the three-dimensional configuration view.

A method for transmitting data from the movable object is, for example, a method of deciding a collection condition to collect probe information on the basis of a communication state in a collection target region of probe information and transmitting the probe information from a vehicle suitable for the collection condition (e.g., see Patent Literature 1).

### CITATION LIST

### Patent Literature

Patent Literature 1: Japanese Patent Application Laid-open No. 2008-77143

### DISCLOSURE OF INVENTION

### Technical Problem

However, in this method, data, e.g., probe information is transmitted only from a movable object such as the vehicle suitable for the collection condition, so there is a fear that it is difficult to transmit all required data depending on the communication state.

Therefore, there is a demand for transmitting all required three-dimensional configuration view data by efficiently transmitting the three-dimensional configuration view data from the movable object, but such a demand has not been adequately met.

The present technology has been made in view of such circumstances to allow efficient transmission of three-dimensional configuration view data from a movable object.

### Solution to Problem

A communication management system according to a first aspect of the present technology is a communication management system including a plan generating unit that generates, on the basis of a state of a transmission channel on a movement route of a movable object and a priority of three-dimensional configuration view data to be used for generating a three-dimensional configuration view, a plan of a transmission timing that is a spatial timing at which the movable object transmits the three-dimensional configuration view data on the transmission channel.

A communication management method according to the first aspect of the present technology is a communication management method including, by a communication management system, generating, on the basis of a state of a transmission channel on a movement route of a movable object and a priority of three-dimensional configuration view data to be used for generating a three-dimensional configuration view, a plan of a transmission timing that is a spatial timing at which the movable object transmits the three-dimensional configuration view data on the transmission channel.

In the first aspect of the present technology, the plan of the transmission timing that is the spatial timing at which the movable object transmits the three-dimensional configuration view data on the transmission channel is generated on the basis of the state of the transmission channel on the movement route of the movable object and the priority of the three-dimensional configuration view data to be used for generating the three-dimensional configuration view.

A movable object according to a second aspect of the present technology is a movable object including a communication unit that transmits three-dimensional configuration view data in accordance with a plan of a transmission timing that is a spatial timing to transmit the three-dimensional configuration view data, the plan being generated on the basis of a state of a transmission channel on a movement route of the movable object and a priority of the three-dimensional configuration view data to be used for generating a three-dimensional configuration view.

In the second aspect of the present technology, the three-dimensional configuration view data is transmitted in accordance with the plan of the transmission timing that is the spatial timing to transmit the three-dimensional configuration view data generated on the basis of the state of the transmission channel on the movement route of the movable object and the priority of the three-dimensional configuration view data to be used for generating the three-dimensional configuration view.

A management apparatus according to a third aspect of the present technology is a management apparatus including: a plan generating unit that generates, on the basis of a state of a transmission channel on a movement route of a movable object and a priority of three-dimensional configuration view data to be used for generating a three-dimensional configuration view, a plan of a transmission timing that is a spatial timing at which a movable object transmits the three-dimensional configuration view data on the transmission channel; and a communication unit that sends to the movable object transmission plan information representing the plan generated by the plan generating unit.

In the third aspect of the present technology, the plan of the transmission timing that is the spatial timing at which the movable object transmits the three-dimensional configuration view data on the transmission channel is generated on the basis of the state of the transmission channel on the movement route of the movable object and the priority of the three-dimensional configuration view data to be used for generating the three-dimensional configuration view, and the transmission plan information represented by the plan is sent to the movable object.

It should be noted that the communication includes wireless communication and wired communication as a matter of course and may include communication where the wireless communication and the wired communication are mixed, that is, the wireless communication may be performed in a certain interval and the wired communication may be performed in another interval. In addition, the wired communication may be performed from a certain device to another device and the wireless communication may be performed from the other device to the certain apparatus.

The communication management system according to the first aspect, the movable object according to the second aspect, and the management apparatus according to the third aspect can be realized by causing a computer to execute a program.

Moreover, the program to be executed by the computer for realizing the communication management system according to the first aspect, the movable object according to the second aspect, and the management apparatus according to the third aspect can be provided by transmitting the program via a transmission medium or recording the program on a recording medium.

### BRIEF DESCRIPTION OF DRAWINGS

FIG. 1 A block diagram showing a configuration example of a first embodiment of a communication management system to which the present technology is applied.

FIG. 2 A view describing an example of a priority of each piece of layer data in each region.

FIG. 3 A view describing an example of a transmission plan.

FIG. 4 A view describing an example of a transmission schedule.

FIG. 5 A flowchart describing map update processing.

FIG. 6 A block diagram showing a configuration example of a second embodiment of the communication management system to which the present technology is applied.

FIG. 7 A view describing an example of a priority of each piece of layer data in each region.

FIG. 8 A view describing an example of a transmission plan.

FIG. 9 A view describing an example of a transmission schedule.

FIG. 10 A flowchart describing three-dimensional spatial model update processing.

FIG. 11 A block diagram showing a configuration example of hardware of a computer.

### MODE(S) FOR CARRYING OUT THE INVENTION

Hereinafter, modes for carrying out the present technology (hereinafter, referred to as embodiments) will be described. It should be noted that the description will be given in the following order.
1. First Embodiment (Communication Management System Including Single Movable Object)
2. Second Embodiment (Communication Management System Including Plurality of Movable Objects)
3. Computer

### First Embodiment

### <Configuration Example of Communication Management System>

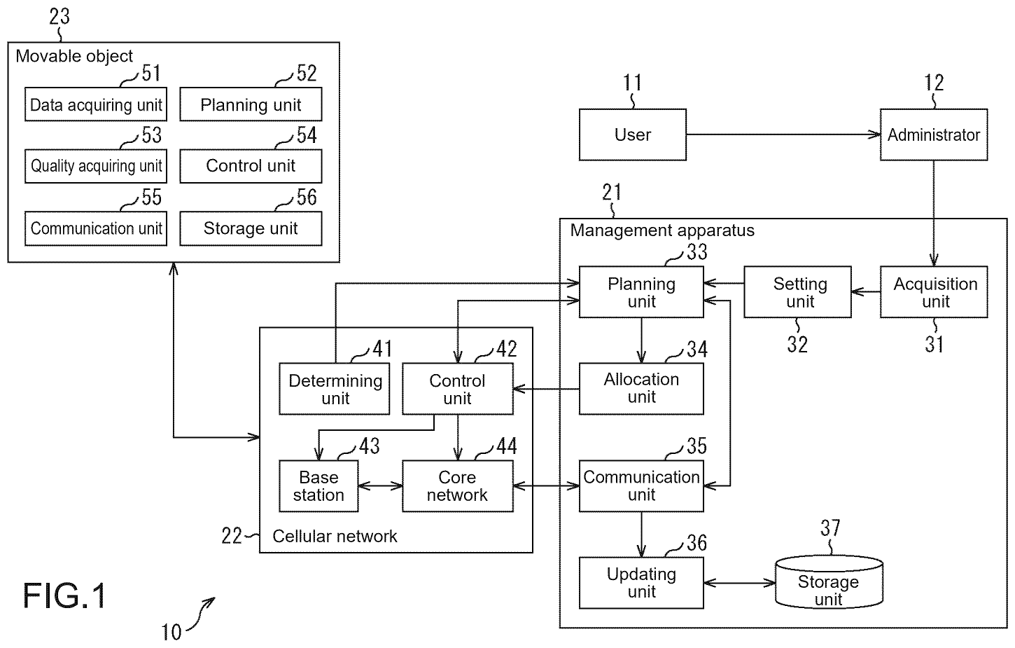

FIG. 1 is a block diagram showing a configuration example of a first embodiment of a communication management system to which the present technology is applied.

As shown in FIG. 1, a communication management system 10 is used by an administrator 12 who has been requested from a user 11 to update a high definition (HD) map that is a high-accuracy three-dimensional map as a three-dimensional configuration view.

The user 11 sets desired requirements of the HD map. The requirements of the HD map are, for example, quality requirements such as accuracy, e.g., resolution of the HD map, a feature amount, and an update frequency, allowable requirements such as an allowable delay time of update, and cost requirements such as a cost that can be spent to secure bandwidth during update. The administrator 12 analyzes desired requirements of the HD map set by the user 11, generates an update plan of the HD map, and inputs it to the communication management system 10.

The communication management system 10 includes a management apparatus 21, a cellular network 22, and a movable object 23. The communication management system 10 updates the HD map by using three-dimensional map data (three-dimensional configuration view data) transmitted from the movable object 23 on the basis of the update plan input by the administrator 12.

Specifically, the management apparatus 21 includes an acquisition unit 31, a setting unit 32, a plan generating unit 33, an allocation unit 34, a communication unit 35, an update unit 36, and a saving unit 37.

The acquisition unit 31 acquires the update plan of the HD map input from the administrator 12 and supplies it to the setting unit 32.

The setting unit 32 sets update requirements of the HD map on the basis of the update plan of the HD map supplied by the acquisition unit 31 and the requirements of the management apparatus 21. Here, one or more pieces of data constituting the three-dimensional map data is layered in accordance with a speed of change in the feature amount of the data. As one of the update requirements of the HD map, a priority when the layer data is used for updating the HD map is set for each region where the movable object 23 is present when layer data that is data in each layer is acquired. As to the layer data with a higher priority, a higher update frequency is requested in update of the HD map.

The update requirements of the HD map include the cost that can be spent to secure bandwidth during update, the accuracy of the HD map, and the like as well as the priority of each piece of layer data in each region. The setting unit 32 supplies the set update requirements of the HD map to the plan generating unit 33.

The plan generating unit 33 acquires communication state information representing a communication state of each time zone of a transmission channel in each cell of the cellular network 22, the communication state information being supplied by the cellular network 22. The communication state information is, for example, a degree of congestion representing a degree of congestion state in each time zone of the transmission channel in each cell. The plan generating unit 33 requests bandwidth information of the movement route from the cellular network 22 on the basis of the movement route information representing the movement route of the movable object 23 supplied by the communication unit 35. The plan generating unit 33 acquires the bandwidth information supplied by the cellular network 22 in accordance with the request.

Here, the transmission channel in each cell has a plurality of layers with different assumed values of communication quality such as a communication priority. The layer of the transmission channel is a slice or the like to be used in a fifth generation mobile communication system (5G) technology. The information representing the assumed value of the communication quality of the transmission channel is 5G quality of service (QOS) identifier (5QI) or the like. The cost required to secure bandwidth of the transmission channel differs depending on each layer. For example, the cost for each layer is set so that the higher the communication quality, the higher the cost. The bandwidth information refers to information representing the cost required to secure bandwidth for each layer of the transmission channel in each cell and the assumed value of the communication quality.

On the basis of the communication state information and the movement route information, the plan generating unit 33 detects the state of the transmission channel in each cell on the movement route of the movable object 23. On the basis of the state of the transmission channel, the bandwidth information, and the update requirements of the HD map, the plan generating unit 33 generates plans of a transmission timing including temporal and spatial timings at which the movable object 23 transmits each piece of layer data on the transmission channel and a transmission layer that is a layer of the transmission channel.

Specifically, the plan generating unit 33 generates a plan of a transmission cell that is a cell in which the movable object 23 is present when transmitting the layer data as a plan of the spatial transmission timing. The plan generating unit 33 generates a plan of a transmission time representing a time between movement of the movable object 23 into the transmission cell to transmission of the layer data by the movable object 23 as a plan of the temporal transmission timing. The plan generating unit 33 supplies transmission plan information representing transmission plans that are the generated plans to the allocation unit 34 and the communication unit 35.

The allocation unit 34 allocates the transmission layer of the transmission cell in the transmission time to transmission of the layer data so that the layer data is transmitted at the transmission timing and in the transmission layer according to the transmission plan information supplied by the plan generating unit 33. Specifically, the allocation unit 34 generates allocation information representing the transmission time, the transmission cell, and the transmission layer and supplies it to the cellular network 22, thereby requesting control of the transmission channel.

The communication unit 35 receives the movement route information sent from the movable object 23 via the cellular network 22 and supplies it to the plan generating unit 33. The communication unit 35 sends the transmission plan information supplied by the plan generating unit 33 to the movable object 23 via the cellular network 22. The communication unit 35 receives the layer data transmitted on the transmission channel in the transmission layer from the movable object 23 present in the transmission cell in the transmission time via the cellular network 22 and supplies it to the update unit 36.

The update unit 36 reads out the HD map saved in the saving unit 37. The update unit 36 updates the HD map on the basis of the layer data supplied by the communication unit 35 and supplies the updated HD map to the saving unit 37.

In the saving unit 37, the HD map is saved in advance. The saving unit 37 updates the saved HD map by using the HD map supplied by the update unit 36.

The cellular network 22 is owned and managed by a communications service company. The cellular network 22 includes a determining unit 41, a control unit 42, a base station 43, and a core network 44.

The determining unit 41 determines the communication state of each cell and supplies communication state information representing the communication state to the plan generating unit 33.

The control unit 42 manages bandwidth information of each cell. The control unit 42 supplies the bandwidth information of each cell on the movement route of the movable object 23 to the plan generating unit 33 in accordance with a request from the plan generating unit 33. The control unit 42 controls the base station 43 and the core network 44, thereby controlling communication between the movable object 23 and the management apparatus 21. For example, the control unit 42 generates transmission control information on the basis of the allocation information supplied by the allocation unit 34 and controls the base station 43 to secure bandwidth of the transmission channel in the transmission layer for the movable object 23 present in the transmission cell in the transmission time represented by the allocation information. The control unit 42 supplies the transmission control information to the base station 43.

The base station 43 performs wireless communication with the movable object 23 under the control of the control unit 42. Specifically, the base station 43 receives the movement route information wirelessly sent from the movable object 23 and sends it to the management apparatus 21 via the core network 44. The base station 43 wirelessly transmits the transmission plan information sent from the communication unit 35 via the core network 44, to the movable object 23. On the basis of the transmission control information supplied by the control unit 42, the base station 43 allocates the transmission channel in the transmission layer to the movable object 23 present in the transmission cell in the transmission time and receives the layer data transmitted from the movable object 23 on the transmission channel. The base station 43 sends the layer data to the management apparatus 21 via the core network 44.

The core network 44 performs communication between the base station 43 and the management apparatus 21 under the control of the control unit 42.

The movable object 23 is a movable robot such as a vehicle, a robot, or a drone. The movable object 23 includes a data acquiring unit 51, a planning unit 52, a quality acquiring unit 53, a control unit 54, a communication unit 55, and a storage unit 56.

The data acquiring unit 51 acquires and layers the three-dimensional map data that is sensing data such as captured image data representing three-dimensional information regarding the surrounding environment. The data acquiring unit 51 supplies the resulting layer data of each layer to the control unit 54.

The planning unit 52 plans the movement route of the movable object 23 and moves the movable object 23 on the movement route. The planning unit 52 supplies the movement route information representing the movement route to the control unit 54. The planning unit 52 also acquires position information representing the current position of the movable object 23 and supplies it to the control unit 54.

The quality acquiring unit 53 acquires the actually measured value of the communication quality of the transmission channel with the cellular network 22 and supplies it to the control unit 54.

The control unit 54 supplies the movement route information supplied by the planning unit 52 to the communication unit 55 for sending the movement route information. On the basis of the position information from the planning unit 52, the actually measured value of the communication quality from the quality acquiring unit 53, and the transmission plan information from the communication unit 55, the control unit 54 generates a transmission schedule representing the time to transmit each piece of layer data, the transmission layer, the amount of data and quality of each piece of layer data, and the like.

Specifically, on the basis of the position information and the transmission plan information, the control unit 54 generates a transmission schedule in which the time to transmit is a time that elapses by the transmission time after the movable object 23 moves into the transmission cell. Then, on the basis of the actually measured value of the communication quality, the control unit 54 adjusts the amount of data and quality represented by the transmission schedule. The control unit 54 can stabilize transmission of the layer data by this adjustment.

In accordance with the adjusted transmission schedule, the control unit 54 supplies the layer data supplied by the data acquiring unit 51 to the storage unit 56 for temporarily storing it depending on needs. In accordance with the adjusted transmission schedule, the control unit 54 supplies the layer data from the data acquiring unit 51 or the layer data read out from the storage unit 56 to the communication unit 55 for transmitting it on the transmission channel in the transmission layer after the transmission time after the movable object 23 moves into the transmission cell.

The communication unit 55 wirelessly sends the movement route information supplied by the control unit 54 to the cellular network 22. The communication unit 55 receives the transmission plan information wirelessly sent from the cellular network 22 and supplies it to the control unit 54. The communication unit 55 transmits (upload) the layer data supplied by the control unit 54 on the wireless transmission channel in the transmission layer via the cellular network 22.

The storage unit 56 temporarily stores the layer data supplied by the control unit 54. It should be noted that the storage unit 56 may be provided outside the movable object 23.

### <Example of Priority of Layer Data>

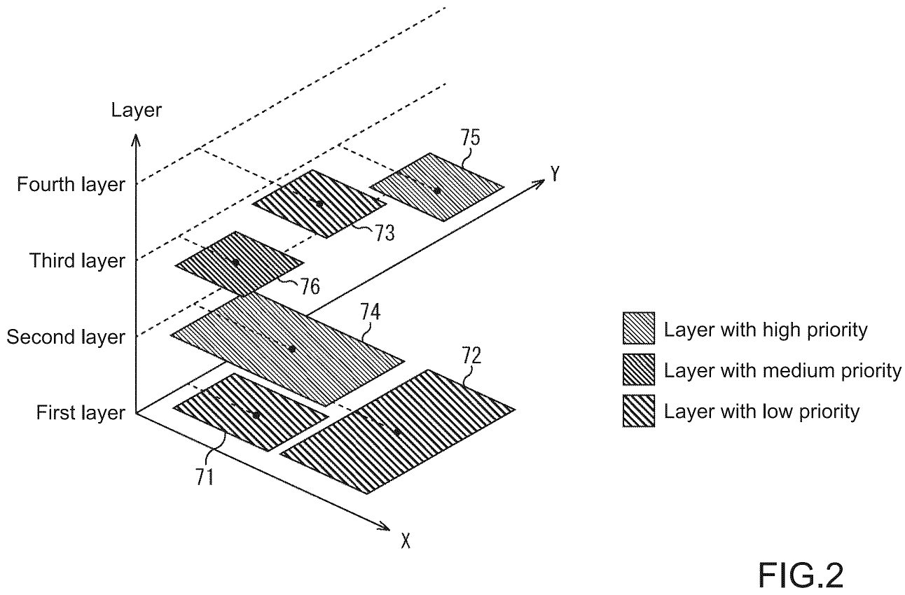

FIG. 2 is a view describing an example of the priority of each piece of layer data in each region.

It should be noted that in FIG. 2, the X-axis represents a position in the X direction of the movable object 23 when acquiring each piece of layer data and the Y-axis represents a position in the Y direction. The Z-axis represents a layer of each piece of layer data.

In the example of FIG. 2, the data constituting the three-dimensional map data is layered into four layers in accordance with the speed of change in the feature amount of the data. Specifically, layer data of a first layer is static data in which the speed of change in the feature amount of the layer data is low or zero. Layer data of a second layer is quasi-static data in which the speed of change in the feature amount of the layer data is higher as compared to the feature amount of the static data. Layer data of a third layer is quasi-dynamic data in which the speed of change in the feature amount of the layer data is higher as compared to the feature amount of the quasi-static data. The quasi-dynamic data is, for example, captured image data at a construction site. Layer data of a fourth layer is dynamic data in which the speed of change in the feature amount of the layer data is higher as compared to the feature amount of the quasi-dynamic data. The dynamic data is, for example, captured image data of another moving vehicle.

In the example of FIG. 2, the layer data of the first layer acquired by the movable object 23 in regions 71 and 72 is static data with a low priority when used for updating the HD map. In the region 73, the layer data of the fourth layer acquired by the movable object 23 is dynamic data with a low priority when used for updating the HD map. In the region 74, the layer data of the second layer acquired by the movable object 23 is quasi-static data with a high priority when used for updating the HD map. In a region 75, the layer data of the third layer acquired by the movable object 23 is quasi-dynamic data with a high priority when used for updating the HD map. In a region 76, the layer data of the third layer acquired by the movable object 23 is quasi-dynamic data with a medium priority when used for updating the HD map.

In this case, as shown in FIG. 2, the setting unit 32 sets a low priority that is the lowest priority as a priority of the layer data of the first layer in the regions 71 and 72 and the layer data of the fourth layer in the region 73. The setting unit 32 sets a high priority that is the highest priority as a priority of the layer data of the second layer in the region 74 and the layer data of the third layer in the region 75. The setting unit 32 sets a medium priority that is a priority between the low priority and the high priority as a priority of the layer data of the third layer in the region 76.

### <Example of Transmission Plan>

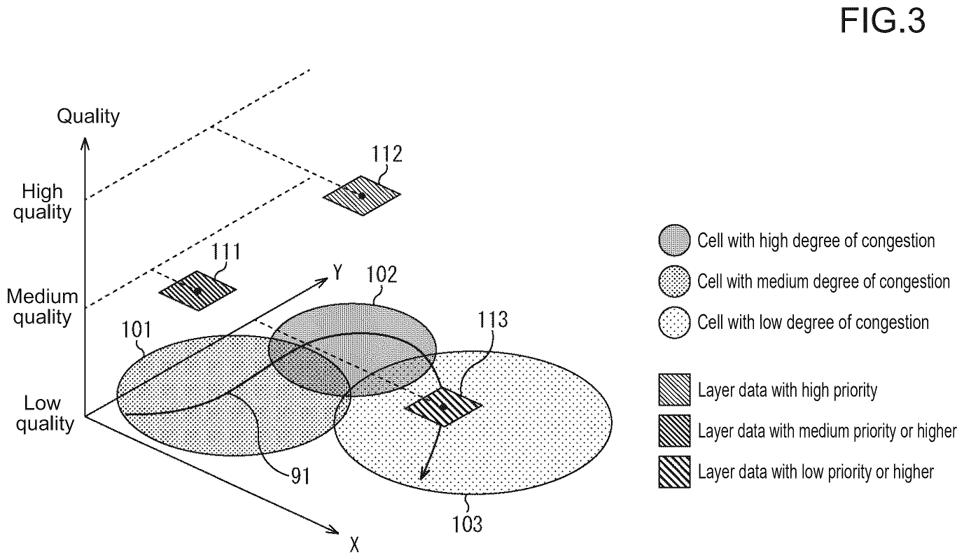

FIG. 3 is a view describing an example of the transmission plan.

It should be noted that in FIG. 3, the X-axis represents a position in the X direction of the movable object 23 when transmitting each piece of layer data and the Y-axis represents a position in the Y direction. The Z-axis represents an assumed value of the communication quality corresponding to the transmission layer of each piece of layer data.

In the example of FIG. 3, a movement route 91 of the movable object 23 extends across three cells 101 to 103. The degree of congestion of the cell 101 is a medium degree of congestion that is higher than a first threshold and that is equal to or lower than a second threshold. The degree of congestion of the cell 102 is a high degree of congestion that is a degree of congestion higher than the second threshold. The degree of congestion of the cell 103 is a low degree of congestion that is a degree of congestion equal to or lower than the first threshold.

In this case, for example, in a case where the movable object 23 is present in the cell 101 with the medium degree of congestion, the plan generating unit 33 generates a transmission plan in accordance with a transmission policy to transmit the layer data with a medium priority or higher on a transmission channel in a layer with medium quality (medium priority). Specifically, the plan generating unit 33 generates a transmission plan in which the transmission cell of the layer data with a medium priority and a high priority that has not yet been transmitted is the cell 101, a predetermined time is the transmission time, and the transmission layer is a layer with medium quality and medium cost.

As a result, layer data 111 with a medium priority acquired in the cell 101 is transmitted on the transmission channel in the layer with medium quality and medium cost in the cell 101 with the medium degree of congestion. On the other hand, the layer data with a low priority acquired in the cell 102 is temporarily stored in the storage unit 56.

For example, in a case where the movable object 23 is present in the cell 102 with a high degree of congestion, the plan generating unit 33 also generates a transmission plan in accordance with a transmission policy to transmit the layer data with a high priority on the transmission channel in the layer with high quality (high priority). Specifically, the plan generating unit 33 generates a transmission plan in which the transmission cell of the layer data with a high priority that has not yet been transmitted is the cell 102, the predetermined time is the transmission time, and the transmission layer is a layer with high quality and high cost.

Accordingly, the layer data 112 with a high priority acquired in the cell 102 is transmitted on the transmission channel in the layer with high quality at a high cost in the cell 102 even in a case where it is the cell 102 with a high degree of congestion. That is, in a case where the cell when the movable object 23 acquires the three-dimensional map data is the cell 102 with a high degree of congestion, the communication unit 55 transmits the layer data with a high priority when acquiring the layer data with a high priority of the three-dimensional map data. On the other hand, the layer data with a medium priority and a low priority is temporarily stored in the storage unit 56.

In a case where the movable object 23 is present the cell 103 with a low degree of congestion, the plan generating unit 33 also generates a transmission plan in accordance with a transmission policy to transmit the layer data with a medium priority or higher on the transmission channel in the layer with low quality (low priority). Specifically, the plan generating unit 33 generates a transmission plan in which the transmission cell of the layer data with all priority that has not yet been transmitted is the cell 103, the predetermined time is the transmission time, and the transmission layer is a layer with low quality and low cost. It should be noted that the transmission time is decided to be a time estimated to have the lowest degree of congestion between the time when the movable object 23 moves to the transmission cell and the time when the movable object 23 moves to another cell, for example, on the basis of the communication state information.

Accordingly, the layer data 113 with a low priority acquired in the cells 101 to 103 is transmitted on the transmission channel in the layer with low quality at a lower cost at the time when the degree of congestion is estimated to be the lowest in the cell 103 with a low degree of congestion. That is, in a case where the cell when the movable object 23 acquires the three-dimensional map data is the cell 103 with a low degree of congestion, the communication unit 55 transmits the three-dimensional map data and the layer data with a medium priority and a low priority that is temporarily stored in the storage unit 56.

As described above, the plan generating unit 33 generates a transmission plan in which all the cells 101 to 103 are transmission cells of the layer data with a high priority, and therefore the layer data with a high priority is transmitted in the same cell as the cell in which the layer data has been acquired. That is, in a case where the priority of the layer data is high, the plan generating unit 33 generates a transmission plan so that a difference between the acquisition timing that is the spatial timing at which the movable object 23 acquires the layer data and the spatial timing to transmit the layer data decreases. It should be noted that although in the example of FIG. 3, the layer data with a high priority is transmitted in the same cell as the cell in which the layer data has been acquired, a cell other than the same cell may be used as long as it is a neighbor cell.

The plan generating unit 33 generates a transmission plan in which the cell 103 with a low degree of congestion is the transmission cell of the layer data with a medium priority or higher that has not yet been transmitted, and therefore the layer data with a low priority that has not been transmitted in the cells 101 and 102 is transmitted when the movable object 23 moves into the cell 103 with a low degree of congestion. That is, in a case where the priority of the layer data is low, the plan generating unit 33 generates a transmission plan so that the transmission timing of the layer data becomes the timing at which the movable object 23 is present in the cell 103 with a low degree of congestion.

### <Example of Transmission Schedule>

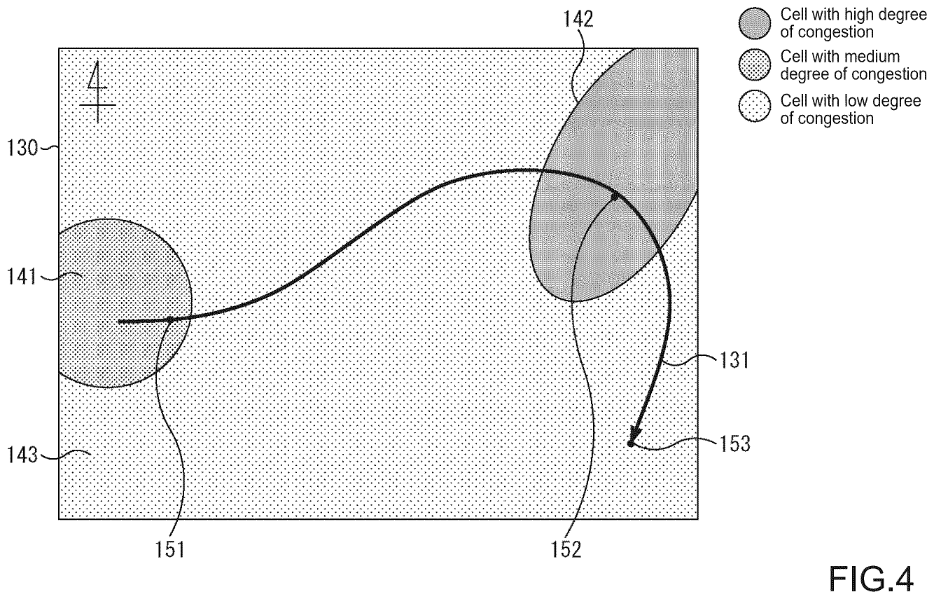

FIG. 4 is a view describing an example of the transmission schedule.

The example of FIG. 4 is an example in a case of acquiring three-dimensional map data necessary for updating an HD map of a large urban area while the movable object 23 that is a self-driving car is moving. FIG. 4 shows a movement route 131 of the movable object 23 on a map 130 of the urban area on which the HD map is to be updated. In the example of FIG. 4, the degree of congestion of a cell in a region 141 on the west side of the urban area is the medium degree of congestion, the degree of congestion of the cell in a region 142 on the northeast side is a high degree of congestion, and the degree of congestion in another region 143 is a low degree of congestion.

In this case, the control unit 54 generates a transmission schedule to transmit the layer data with a medium priority and a high priority that has not yet been transmitted on the transmission channel in the layer with a medium cost and medium quality, for example, at the time when the movable object 23 moves a point 151 in the region 141 on the west side. Accordingly, the layer data with a medium priority or a high priority that has been acquired by the movable object 23 by the time it moves to the point 151 is immediately transmitted on the transmission channel in the layer with a medium cost and medium quality that is secured for the movable object 23 at the point 151.

The control unit 54 generates a transmission schedule to transmit the layer data with a high priority that has not yet been transmitted on the transmission channel in the layer with high quality at a high cost, for example, at the time when the movable object 23 moves to a point 152 in the region 142 on the northeast side. Accordingly, the layer data with a high priority that has been acquired by the movable object 23 by the time it moves the point 152 from the point 151 is immediately transmitted on the transmission channel in the layer with high quality at a high cost secured for the movable object 23 at the point 152.

The control unit 54 generates a transmission schedule to transmit the layer data with all priority that has not yet been transmitted on the transmission channel in the layer with low quality at low cost at the time when the degree of congestion is estimated to be the lowest in the cell in the region 143 through which the movable object 23 passes, in the example of FIG. 4, at the time when the movable object 23 moves to a final point 153. Accordingly, for example, the layer data with a low priority that has been acquired during the movement from the point 151 to the final point 153 and the layer data with a medium priority that has been acquired during the movement from the point 152 to the final point 153 are collectively transmitted on the transmission channel in the layer with low quality at low cost secured for the movable object 23 at the final point 153.

### <Description of Map Update Processing>

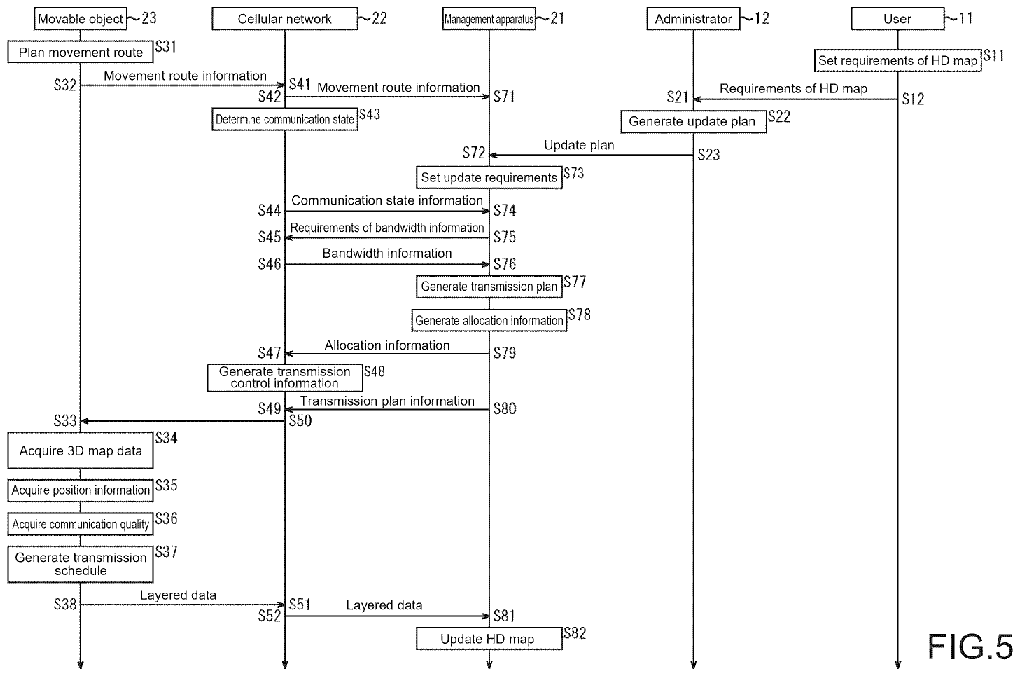

FIG. 5 is a flowchart describing map update processing of updating the HD map by the communication management system 10.

In Step S11 of FIG. 5, the user 11 sets desired requirements of the HD map. In Step S12, the user 11 transmits the requirements of the HD map set in Step S11 to the administrator 12.

In Step S21, the administrator 12 receives the requirements of the HD map transmitted by the user 11. In Step S22, the administrator 12 analyzes the requirements of the HD map received in Step S21 and generates an update plan of the HD map. In Step S23, the administrator 12 inputs the update plan generated in Step S22 to the management apparatus 21 of the communication management system 10.

On the other hand, in Step S31, the planning unit 52 of the movable object 23 plans the movement route of the movable object 23 and supplies movement route information representing the movement route to the communication unit 55 via the control unit 54. In Step S32, the communication unit 55 wirelessly sends the movement route information to the cellular network 22.

In Step S41, the base station 43 of the cellular network 22 receives the movement route information sent by the processing in Step S32. In Step S42, the base station 43 sends the movement route information received by the processing in Step S41 to the management apparatus 21 via the core network 44.

In Step S71, the communication unit 35 of the management apparatus 21 receives the movement route information transmitted by the processing in Step S42 and supplies it to the plan generating unit 33. In Step S72, the acquisition unit 31 acquires the update plan input by the processing in Step S23 and supplies it to the setting unit 32. In Step S73, the setting unit 32 sets the update requirements of the HD map and supplies them to the plan generating unit 33 on the basis of the update plan acquired in Step S72 and the requirements of the management apparatus 21.

In Step S43 after the processing in Step S42, the determining unit 41 determines the communication state of each cell. In Step S44, the determining unit 41 supplies the communication state information representing the communication state determined in the processing in Step S43 to the plan generating unit 33.

In Step S74, the plan generating unit 33 acquires the communication state information supplied by the processing in Step S44. In Step S75, the plan generating unit 33 requests the bandwidth information of the movement route from the cellular network 22 on the basis of the movement route information received by the processing in Step S71.

In Step S45, the control unit 42 receives the request by the processing in Step S75. In Step S46, the control unit 42 supplies the bandwidth information of each cell on the movement route of the movable object 23 to the plan generating unit 33 in accordance with the request received by the processing in Step S45.

In Step S76, the plan generating unit 33 acquires the bandwidth information supplied by the processing in Step S46. In Step S77, the plan generating unit 33 generates a transmission plan on the basis of the movement route information, the update requirements, the communication state information, and the bandwidth information. Then, the plan generating unit 33 supplies the transmission plan information representing the transmission plan to the allocation unit 34 and the communication unit 35.

In Step S78, the allocation unit 34 generates allocation information so that the layer data is transmitted at the transmission timing and in the transmission layer according to the transmission plan information supplied by the processing in Step S77. In Step S79, the allocation unit 34 supplies to the allocation information generated by the processing in Step S78 to the cellular network 22.

In Step S47, the control unit 42 acquires the allocation information supplied by the processing in Step S79. In Step S48, the control unit 42 generates transmission control information for controlling the base station 43 to secure bandwidth of the transmission channel in the transmission layer for the movable object 23 present in the transmission cell and supplies it to the base station 43 at the transmission time represented by the allocation information acquired by the processing in Step S47. Accordingly, the base station 43 allocates the transmission channel in the transmission layer to the movable object 23 present in the transmission cell in the transmission time on the basis of the transmission control information.

In Step S80 after the processing in Step S79, the communication unit 35 sends the transmission plan information supplied by the processing in Step S77 to the movable object 23.

In Step S49, the base station 43 receives the transmission plan information sent via the core network 44 by the processing in Step S80. In Step S50, the base station 43 wirelessly sends the transmission plan information received by the processing in Step S49 to the movable object 23.

In Step S33, the communication unit 55 receives the transmission plan information sent by the processing in Step S50 and supplies it to the control unit 54. In Step S34, the data acquiring unit 51 acquires and layers the three-dimensional map data and supplies the resulting layer data of each layer to the control unit 54. The layer data is temporarily stored in the storage unit 56 depending on needs.

In Step S35, the planning unit 52 acquires position information and supplies it to the control unit 54. In Step S36, the quality acquiring unit 53 acquires an actually measured value of the communication quality of the transmission channel with the cellular network 22 and supplies it to the control unit 54. In Step S37, the control unit 54 generates a transmission schedule on the basis of the position information, the actually measured value of the communication quality, and the transmission plan information.

In Step S38, in accordance with the transmission schedule generated by the processing in Step S37, the control unit 54 supplies the layer data to the communication unit 55 after the transmission time after the movable object 23 moves into the transmission cell, thereby causing the layer data to be transmitted on the transmission channel in the transmission layer.

In Step S51, the base station 43 receives the layer data transmitted by the processing in Step S38. In Step S52, the base station 43 sends the layer data received by the processing in Step S51 to the management apparatus 21 via the core network 44.

In Step S81, the communication unit 35 receives the layer data transmitted by the processing in Step S52 and supplies it to the update unit 36. In Step S82, the update unit 36 updates the HD map saved in the saving unit 37 on the basis of the layer data received by the processing in Step S81 and supplies the updated HD map to the saving unit 37 for saving it.

The processing in Steps S34 to S38, the processing in Steps S51 and S52, and the processing in Steps S81 and S82 described above are repeatedly performed until the movable object 23 arrives at the final point of the movement route.

As described above, the plan generating unit 33 generates a plan of the spatial timing at which the movable object 23 transmits the three-dimensional map data on the transmission channel on the basis of the state of the transmission channel on the movement route of the movable object 23 and the priority of the three-dimensional map data. Thus, it is possible to efficiently transmit the three-dimensional map data from the movable object 23.

As a result, the management apparatus 21 is capable of efficiently collecting necessary three-dimensional map data with high quality and updating a large-scale HD map even in a case where the upload throughput degrades in accordance with the degree of congestion or the like of the transmission channel due to constraints of allocation of the bandwidth (network resources) of the transmission channel and the degree of congestion changes along with the movement of the movable object 23.

In contrast, in a case of transmitting the three-dimensional map data with all priority in the layer with high quality at a high cost in real time, necessary three-dimensional map data can be collected with high quality, but the bandwidth utilization efficiency is low and the cost required to secure bandwidth is higher.

It should be noted that the movement route of the movable object 23 may be decided by the management apparatus 21 on the basis of the update plan of the HD map. In this case, the management apparatus 21 transmits the movement route information to the movable object 23 via the cellular network 22.

### Second Embodiment

### <Configuration Example of Communication Management System>

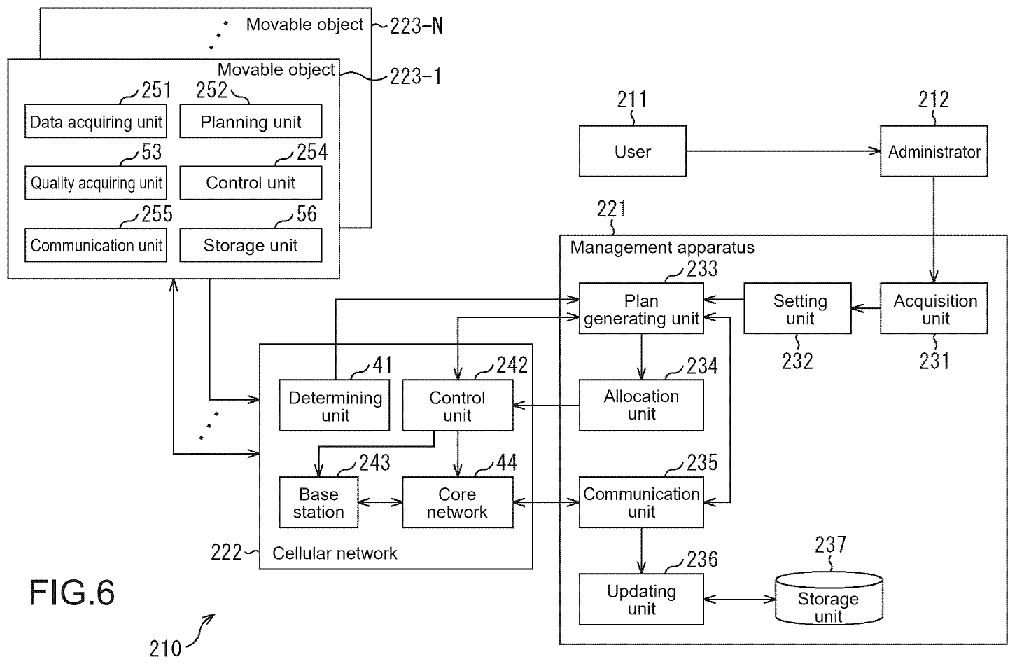

FIG. 6 is a block diagram showing a configuration example of a second embodiment of the communication management system to which the present technology is applied.

In a communication management system 210 in FIG. 6, portions corresponding to those of the communication management system 10 in FIG. 1 are denoted by the same reference signs. Thus, the description of the portions is omitted as appropriate, and portions different from the communication management system 10 will be mainly described. The communication management system 210 is different from the communication management system 10 in that a three-dimensional spatial model is updated as a three-dimensional configuration view by using three-dimensional spatial model data simultaneously acquired by a plurality of movable objects, and the other portions are configured to be similar to those of the communication management system 10.

A user 211 sets desired requirements of the three-dimensional spatial model. The requirements of the three-dimensional spatial model are, for example, quality requirements such as accuracy, e.g., resolution of the three-dimensional spatial model, a feature amount, and an update frequency, allowable requirements such as an allowable delay time of update, and cost requirements such as a cost that can be spent to secure bandwidth during update. An administrator 212 analyzes desired requirements of the three-dimensional spatial model set by the user 211, generates an update plan of the three-dimensional spatial model, and inputs it to the communication management system 210.

The communication management system 210 includes a management apparatus 221, a cellular network 222, and N movable objects 223-1 to 223-N (N denotes an integer larger than 1). The communication management system 210 updates the three-dimensional spatial model by using the three-dimensional spatial model data (three-dimensional configuration view data) transmitted from the N movable objects 223-1 to 223-N on the basis of the update plan input by the administrator 212. Hereinafter, in a case where it is not especially necessary to distinguish between the N movable objects 223-1 to 223-N, they will be collectively referred to as movable objects 223.

The management apparatus 221 includes an acquisition unit 231, a setting unit 232, a plan generating unit 233, an allocation unit 234, a communication unit 235, an update unit 236, and a saving unit 237.

The description is omitted because the acquisition unit 231 and the setting unit 232 are similar to the acquisition unit 31 and the setting unit 32, respectively, except that the HD map is relaced by the three-dimensional spatial model and that the three-dimensional map data is relaced by the three-dimensional spatial model data.

The plan generating unit 233 acquires communication state information supplied by the cellular network 222. The plan generating unit 233 requests the cellular network 22 from bandwidth information of the movement route of each movable object 223 on the basis of a pre-set movement route of each movable object 223. As the movement route of each movable object 223, a path to move back and forth between a departure point and an object corresponding to the three-dimensional spatial model is set for example on the basis of the update plan or the like of the three-dimensional spatial model. The plan generating unit 233 acquires the bandwidth information of each movable object 223 supplied by the cellular network 222 in accordance with the request.

The plan generating unit 233 detects a state of the transmission channel in each cell on the movement route of each movable object 223 on the basis of the communication state information and the movement route of each movable object 223. The plan generating unit 233 generates a transmission plan of each movable object 223 on the basis of the state of the transmission channel, the bandwidth information, and the update requirements of the three-dimensional spatial model for each movable object 223. The plan generating unit 233 supplies the transmission plan information of each movable object 223 to the allocation unit 234 and the communication unit 235.

The allocation unit 234 allocates the transmission layer of the transmission cell in the transmission time to transmission of the layer data so that for each movable object 223, the layer data is transmitted at the transmission timing and in the transmission layer according to the transmission plan information supplied by the plan generating unit 33. Specifically, the allocation unit 234 generates allocation information of each movable object 223 and supplies it to the cellular network 22, thereby requesting control of the transmission channel.

The communication unit 235 sends the transmission plan information of each movable object 223 supplied by the plan generating unit 233 to each movable object 223 via the cellular network 22. The communication unit 235 receives the layer data transmitted on the transmission channel in the transmission layer from the movable object 223 present in the transmission cell in the transmission time via the cellular network 222 and supplies it to the update unit 236.

The update unit 236 reads out the three-dimensional spatial model saved in the saving unit 237. The update unit 236 updates the three-dimensional spatial model on the basis of the layer data supplied by the communication unit 235 and supplies the updated three-dimensional spatial model to the saving unit 237.

In the saving unit 237, the three-dimensional spatial model is saved in advance. The saving unit 237 updates the saved three-dimensional spatial model by using the three-dimensional spatial model supplied by the update unit 36.

The cellular network 222 is different from the cellular network 22 in that it includes a control unit 242 and a base station 243 instead of the control unit 42 and the base station 43, and the other portions are configured to be similar to the cellular network 22.

The control unit 242 manages the bandwidth information of each cell. The control unit 242 supplies the movement route of the bandwidth information of each movable object 223 of each cell to the plan generating unit 233 in accordance with the request from the plan generating unit 233. The control unit 242 controls the base station 243 and the core network 44, thereby controlling communication between each movable object 223 and the management apparatus 221. For example, the control unit 242 generates transmission control information for controlling the base station 243 to secure the transmission channel in the transmission layer for the movable objects 223 present in the transmission cell at the transmission time represented by the allocation information on the basis of the allocation information of each movable object 223 from the allocation unit 234. The control unit 242 supplies the transmission control information to the base station 243.

The base station 243 performs wireless communication with each movable object 223 under the control of the control unit 242. Specifically, the base station 243 wirelessly transmits the transmission plan information transmitted to each movable object 223 from the communication unit 235 via the core network 44, to the movable objects 223. On the basis of the transmission control information supplied by the control unit 242, the base station 243 allocates the transmission channel in the transmission layer to the movable object 223 present in the transmission cell in the transmission time and receives the layer data transmitted from the movable objects 223 on the transmission channel. The base station 243 sends the layer data to the management apparatus 221 via the core network 44.

The movable object 223 is, for example, a drone. The movable object 223 is different from the movable object 23 in that it includes a data acquisition unit 251, a planning unit 252, a control unit 254, a communication unit 255 instead of the data acquiring unit 51, the planning unit 52, the control unit 54, the communication unit 55, and the other portions are configured to be similar to those of the movable object 23.

The data acquisition unit 251 is, for example, a vision sensor and acquires and layers difference data representing a difference between a captured image and an image retained in advance as the three-dimensional spatial model data. The data acquisition unit 251 supplies the resulting layer data of each layer to the control unit 254.

The planning unit 252 manages the pre-set movement routes of the movable objects 223 and moves the movable object 23 on the movement route. The planning unit 252 also acquires position information of the movable objects 223 and supplies it to the control unit 254.

As in the control unit 54, the control unit 254 generates a transmission schedule on the basis of the position information from the planning unit 252, the actually measured value of the communication quality from the quality acquiring unit 53, and the transmission plan information from the communication unit 255. In accordance with the transmission schedule, the control unit 254 supplies the layer data supplied by the data acquisition unit 251 to the storage unit 56 for temporarily storing it depending on needs. In accordance with the transmission schedule, the control unit 254 supplies the layer data from the data acquisition unit 251 or the layer data read out from the storage unit 56 to the communication unit 255 for transmitting it on the transmission channel in the transmission layer after the transmission time after the movable object 223 moves to the transmission cell. The communication unit 255 receives the transmission plan information wirelessly sent from the cellular network 222 and supplies it to the control unit 254. The communication unit 255 transmits the layer data supplied by the control unit 254 on the wireless transmission channel in the transmission layer via the cellular network 222.

### <Example of Priority of Layer Data>

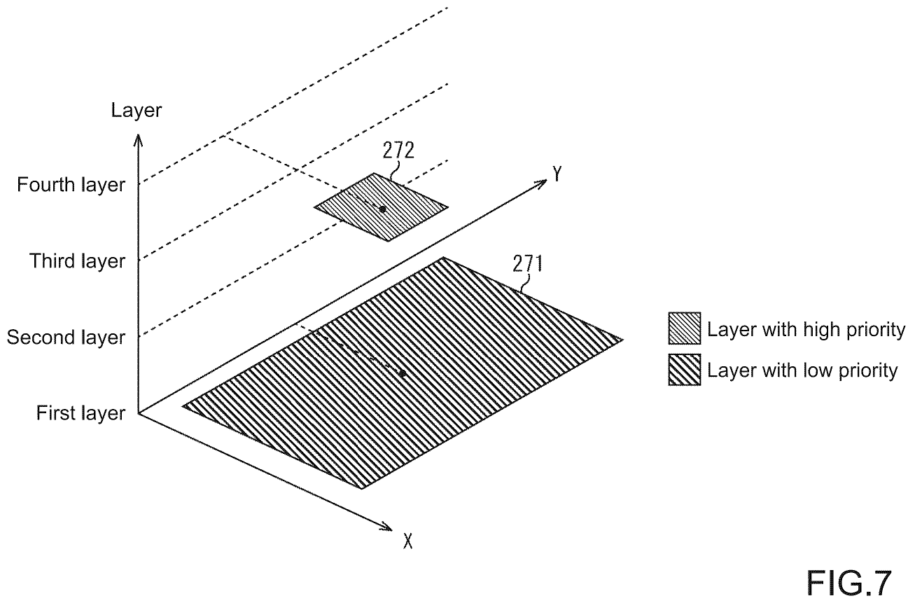

FIG. 7 is a view describing an example of the priority of each piece of layer data in each region.

It should be noted that in FIG. 7, the X-axis represents a position in the X direction of the movable object 223 when acquiring each piece of layer data and the Y-axis represents a position in the Y direction. The Z-axis represents a layer of each piece of layer data.

In the example of FIG. 7, as in the example of FIG. 2, data constituting the three-dimensional spatial model data is layered into four layers in accordance with the speed of change in the feature amount of the data.

In the example of FIG. 7, the layer data of a first layer acquired by the movable object 223 in a region 271 is static data with a low priority when used for updating the three-dimensional spatial model. The layer data of a fourth layer acquired by the movable object 223 in a region 272 is dynamic data with a high priority when used for updating the three-dimensional spatial model.

In this case, as shown in FIG. 7, the setting unit 232 sets a low priority as a priority of the layer data of the first layer in the region 271. The setting unit 232 sets a high priority as a priority of the layer data of the fourth layer in the region 272.

### <Example of Transmission Plan>

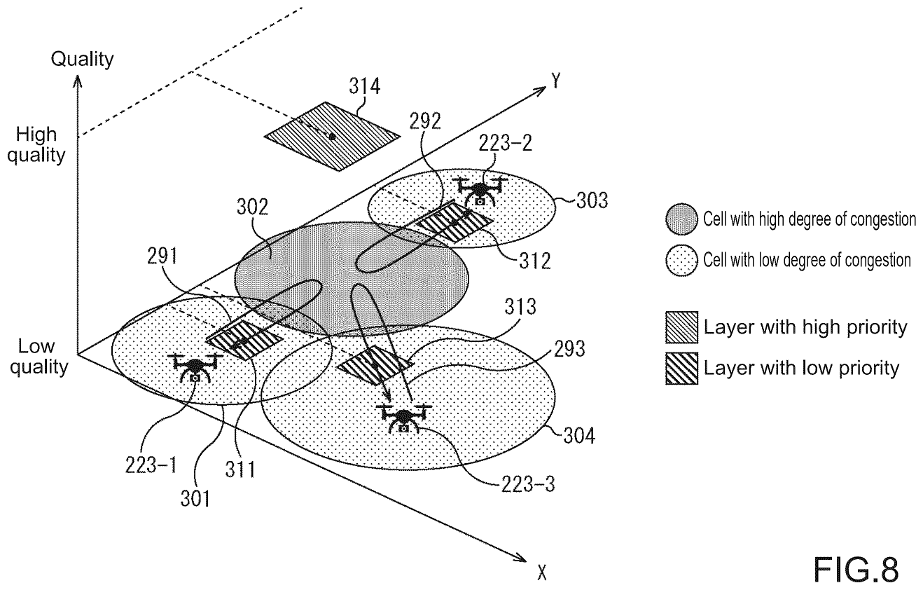

FIG. 8 is a view describing an example of the transmission plan.

It should be noted that in FIG. 8, the X-axis represents a position in the X direction of the movable object 223 when transmitting each piece of layer data and the Y-axis represents a position in the Y direction. The Z-axis represents an assumed value of the communication quality corresponding to the transmission layer of each piece of layer data.

In the example of FIG. 8, N is 3 and each of the movable objects 223-1 to 223-3 that are drones move back and forth. Specifically, the movable object 223-1 moves back and forth between a cell 301 and a cell 302 on a movement route 291. The movable object 223-2 moves back and forth between a cell 303 and the cell 302 on a movement route 292. The movable object 223-3 moves back and forth between a cell 304 and the cell 302 on a movement route 293. In the example of FIG. 8, the degrees of congestion of the cells 301, 303, and 304 are the low degree of congestion and the degree of congestion of the cell 302 is the high degree of congestion.

In this case, for example, in a case where the movable object 223-1 is present in the cell 301 with a low degree of congestion, the plan generating unit 233 generates a transmission plan in accordance with a transmission policy to transmit the layer data with a medium priority or higher on the transmission channel in the layer with low quality. Specifically, the plan generating unit 233 generates a transmission plan in which the transmission cell of the layer data with all priority that has been acquired by the movable object 223-1 and has not yet been transmitted is the cell 301, a predetermined time is the transmission time, and the transmission layer is a layer with low quality and low cost. It should be noted that, as in the example of FIG. 3, for example, on the basis of the communication state information, the transmission time is decided to be a time estimated to have the lowest degree of congestion between the time when the movable object 223-1 moves and the transmission cell to the time when the movable object 223-1 moves to another cell. Accordingly, layer data 311 with a low priority that has been acquired by the movable object 223-1 in the cell 301 or 302 is transmitted on the transmission channel in the layer with low quality at a lower cost at the time when the degree of congestion is estimated to be the lowest in the cell 301 with a low degree of congestion.

Also as to the movable objects 223-2 and 223-3, for example, in a case where the movable object 223-2 (223-3) is present in the cell 303 (304) with a low degree of congestion, the plan generating unit 233 generates a transmission plan in accordance with a transmission policy to transmit the layer data with a medium priority or higher on the transmission channel in the layer with low quality. Accordingly, the layer data with a low priority 312 (313) acquired by the movable object 223-2 (223-3) in the cell 302 or 303 (304) is transmitted on the transmission channel in the layer with low quality at a lower cost in a time zone when the degree of congestion is estimated to be the lowest in the cell 303 (304) with a low degree of congestion.

For example, in a case where the movable objects 223-1 to 223-3 are present in the cell 302 with a high degree of congestion, the plan generating unit 233 also generates a transmission plan in accordance with a transmission policy to transmit the layer data with a high priority on the transmission channel in the layer with high quality. Specifically, the plan generating unit 233 generates a transmission plan in which the transmission cell of the layer data with a high priority that has not yet been transmitted is the cell 302, the predetermined time is the transmission time, and the transmission layer is a layer with high quality at high cost. Accordingly, the layer data 314 with a high priority acquired by the movable objects 223-1 to 223-3 in the cell 302 is transmitted on the transmission channel in the layer with high quality at a high cost in the cell 302 even in the cell 302 with a high degree of congestion.

As described above, the plan generating unit 233 generates a transmission plan in which all the cells 301 to 304 are the transmission cell of the layer data with a high priority, and therefore the layer data with a high priority is transmitted in the same cell as the cell in which the layer data has been acquired.

The plan generating unit 233 generates a transmission plan in which the cells 301, 303, and 304 with a low degree of congestion is the transmission cell of the layer data with a medium priority or higher. Thus, the layer data with a low priority is transmitted when the movable object 223 is present in the cell 301, 303, or 304 with a low degree of congestion.

### <Example of Transmission Schedule>

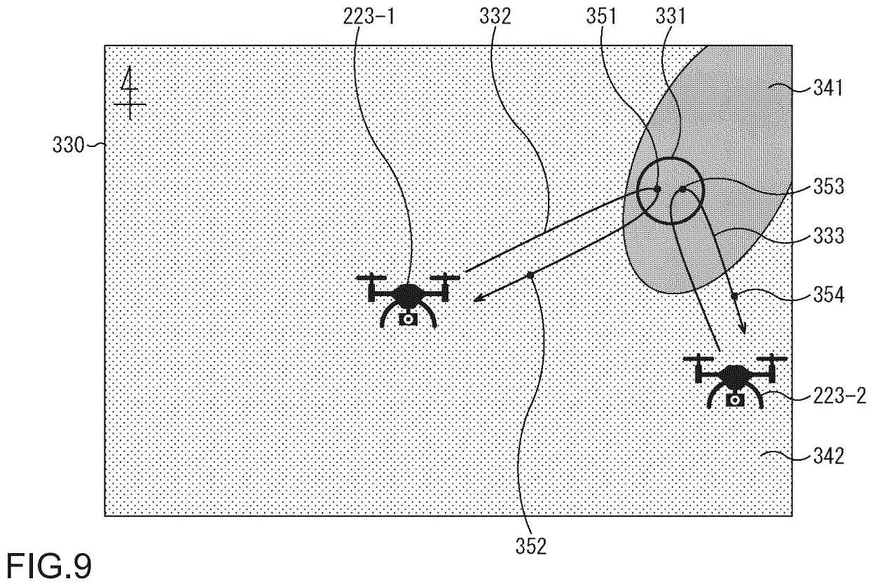

FIG. 9 is a view describing an example of the transmission schedule.

The example of FIG. 9 is an example in a case of updating a three-dimensional spatial model of a construction site in an urban area by using the three-dimensional spatial model data of the two movable objects 223-1 and 223-2 in real time. FIG. 9 shows the map 330 of this urban area.

In the example of FIG. 9, a construction site 331 is located on the east side of the urban area. The movable object 223-1 moves back and forth to the construction site 331 along a movement route 332, thereby acquiring three-dimensional spatial model data of the construction site 331. At the same time, the movable object 223-2 moves back and forth to the construction site 331 along a movement route 333, thereby acquiring the three-dimensional spatial model data of the construction site 331.

In the example of FIG. 9, the degree of congestion of the cell in a region 341 including the construction site 331 is a high degree of congestion and the degree of congestion of another region 342 is a low degree of congestion. In this case, the control unit 254 of the movable object 223-1 generates a transmission schedule to transmit the layer data with a high priority that has not yet been transmitted on the transmission channel in the layer with high quality at a high cost, for example, at the time when the movable object 223-1 moves to a point 351 in the region 341. Accordingly, the layer data with a high priority required to be updated in real time in, for example, the three-dimensional spatial model acquired at the construction site 331 is immediately transmitted on the transmission channel in the layer with high quality at a high cost secured for the movable object 223-1 at the point 351.

The control unit 254 of the movable object 223-1 generates a transmission schedule to transmit the layer data with all priority that has not yet been transmitted on the transmission channel in the layer with low quality at low cost at the time when the degree of congestion is estimated to be the lowest in the cell in the region 342 through which the movable object 223-1 passes, in the example of FIG. 9, at the time when the movable object 223 moves to a point 352. Accordingly, the layer data with a priority lower than the high priority, which has been acquired before reaching the point 352, is collectively transmitted on the transmission channel in the layer with low cost and low quality secured for the movable object 223-1 at the point 352.

The control unit 254 of the movable object 223-2 generates a transmission schedule as in the control unit 254 of the movable object 223-1. Accordingly, the layer data with a high priority that needs to be updated in real time in, for example, the three-dimensional spatial model acquired at the construction site 331 is immediately transmitted on the transmission channel in the layer with high quality at a high cost secured for the movable object 223-2 at a point 353. The layer data with a priority lower than the high priority, which has been acquired before reaching a point 354, is collectively transmitted on the transmission channel in the layer with low cost and low quality secured for the movable object 223-2 at the point 354.

As described above, even in a case where the construction site 331 is the region 341 in the cell with a high degree of congestion, the movable objects 223-1 and 223-2 transmit the simultaneously acquired layer data with a high priority by using the transmission channel in the layer with high quality in real time. Thus, the movable objects 223-1 and 223-2 are capable of simultaneously transmitting the simultaneously acquired layer data with a high priority at or above a certain level of communication quality.

The movable objects 223-1 and 223-2 transmit, for example, layer data that is static data with a low priority acquired in the surrounding region at the construction site 331 or layer data that is non-urgent but high-resolution and ultra-large-volume dynamic data with a low priority, which has been acquired at the construction site 331, in the region 342 in the cell with a low degree of congestion that has excess capacity in communication performance.

It should be noted that the movable objects 223-1 and 223-2 are also capable of generating a transmission schedule so as not to transmit the layer data with a low priority in a cell near the construction site 331 irrespective of the degree of congestion of the transmission channel. Accordingly, the movable objects 223-1 and 223-2 are capable of transmitting the layer data with a low priority in different cells. As a result, the communication quality can be improved as compared to a case of transmitting it in the same cells.

The three-dimensional spatial model of the construction site 331 updated by using the layer data transmitted in the transmission schedule as described above can be used for applications such as progress management of the construction site 331, for example.

### <Description of Three-Dimensional Spatial Model Update Processing>

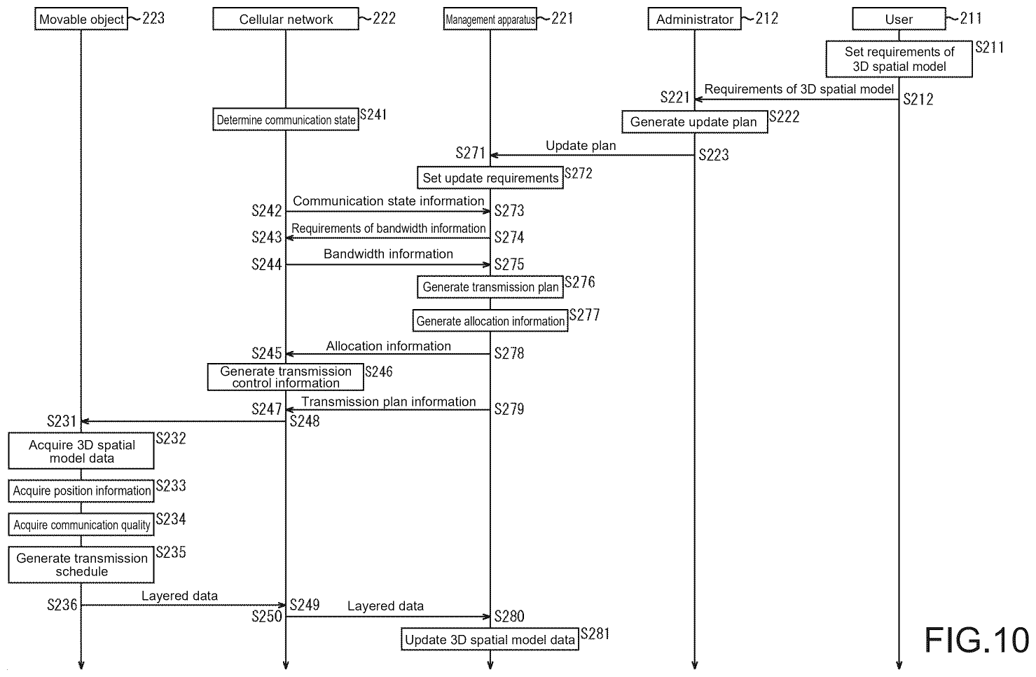

FIG. 10 is a flowchart describing three-dimensional spatial model update processing of updating the three-dimensional spatial model by the communication management system 210.

In Step S211 of FIG. 10, the user 211 sets desired requirements of the three-dimensional spatial model. In Step S212, the user 211 transmits the requirements of the three-dimensional spatial model set in Step S211 to the administrator 212.

In Step S221, the administrator 212 receives the requirements of the three-dimensional spatial model transmitted by the user 211. In Step S222, the administrator 212 analyzes the requirements of the three-dimensional spatial model received by the processing in Step S221 and generates an update plan of the three-dimensional spatial model. In Step S223, the administrator 212 inputs the update plan generated by the processing in Step S222 to the management apparatus 221.

In Step S271, the acquisition unit 231 acquires the update plan input by the processing in Step S223 and supplies it to the setting unit 232. In Step S272, the setting unit 232 sets update requirements of the three-dimensional spatial model on the basis of the update plan acquired by the processing in Step S271 and the requirements of the management apparatus 221 and supplies it to the plan generating unit 233. Then, the processing proceeds to the processing in Step S273.

The processing in Steps S241, S242, and S273 is similar to the processing in Steps S43, S44, and S74 of FIG. 5, so the description is omitted. In Step S274, the plan generating unit 233 requests the bandwidth information of the movement route from the cellular network 222 on the basis of the movement route of each movable object 223 set in advance.

The processing in Steps S243, S244, and S275 is similar to the processing in Steps S45, S46, and S76 of FIG. 5, so the description is omitted.

In Step S276 after the processing in Step S275, the plan generating unit 233 generates a transmission plan on the basis of the movement route information, the update requirements, the communication state information, and the bandwidth information for each movable object 223. Then, the plan generating unit 233 supplies the transmission plan information of each movable object 223 to the allocation unit 234 and the communication unit 235. Then, the processing proceeds to the processing in Step S277.

In Step S277, the allocation unit 234 generates allocation information so that the layer data is transmitted at the transmission timing and in the transmission layer according to the transmission plan information supplied by the processing in Step S277 for each movable object 223. In Step S278, the allocation unit 234 supplies the allocation information of each movable object 223 generated by the processing in Step S277 to the cellular network 222.

In Step S245, the control unit 242 acquires the allocation information of each movable object 223 supplied by the processing in Step S278. In Step S246, the control unit 242 generates transmission control information on the basis of the allocation information of each movable object 223 acquired by the processing in Step S245 and supplies it to the base station 243. Accordingly, the base station 243 allocates the transmission channel in the transmission layer to the movable object 223 present in the transmission cell in the transmission time on the basis of the transmission control information.

In Step S279 after the processing in Step S278, the communication unit 235 sends the transmission plan information of each movable object 223 supplied by the processing in Step S276 to the movable object 223.

In Step S247, the base station 243 receives the transmission plan information addressed to each movable object 223 sent via the core network 44 by the processing in Step S279. In Step S248, the base station 243 wirelessly sends the transmission plan information addressed to each movable object 223 received by the processing in Step S247 to the movable object 23.

In Step S231, the communication unit 255 of each movable object 223 receives the transmission plan information sent by the processing in Step S248 and supplies it to the control unit 254. In Step S232, the data acquisition unit 251 acquires and layers the three-dimensional spatial model data. The data acquisition unit 251 supplies the resulting layer data of each layer to the control unit 254. Then, the processing proceeds to the processing in Step S233. The processing in Steps S233 to S236 is similar to the processing in Steps S35 to 38 of FIG. 5, so the description is omitted.

The processing in Steps S249 and S250 is similar to the processing in Steps S51 and S52 of FIG. 5, so the description is omitted.

In Step S280, the communication unit 235 receives the layer data transmitted by the processing in Step S250 and supplies it to the update unit 236. In Step S281, the update unit 236 updates the three-dimensional spatial model saved in the saving unit 237 on the basis of the layer data received by the processing in Step S280 and supplies the updated three-dimensional spatial model to the saving unit 237 for storing it.

The processing in Steps S232 to S236, the processing in Steps S249 and S250, and the processing in Steps S280 and S281 are repeatedly performed until the movable object 223 arrives at the final point of the movement route.

As described above, the plan generating unit 233 generates the plan of the spatial transmission timing at which each movable object 223 transmits the three-dimensional spatial model data on the transmission channel on the basis of the state of the transmission channel on the movement route of each of the plurality of movable objects 223 and the priority of the three-dimensional spatial model data. Thus, it is possible to efficiently transmit the three-dimensional spatial model data from each movable object 223. As a result, even if there are constraints on allocation of the bandwidth of the transmission channel, the management apparatus 221 is capable of efficiently collecting three-dimensional spatial model data in a plurality of viewpoints from the plurality of movable objects 223 at high speed and updating the three-dimensional spatial model.

Although in the second embodiment, the three-dimensional spatial model has been updated, an extensive HD map may be updated by using the three-dimensional map data as in the first embodiment. In this case, the management apparatus 221 may set the movement route of each movable object 223 in advance. Alternatively, each movable object 223 may set the movement route of each movable object 223 and the movement route information may be transmitted to the management apparatus 221.

It should be noted that the communication management system 10 (210) may generate the HD map (three-dimensional spatial model) rather than updating the HD map (three-dimensional spatial model).

The transmission time and the transmission layer of the layer data with different priorities that is transmitted in the same cell may be different. For example, as long as the HD map (three-dimensional spatial model) can be updated in a cost range of the update requirements of the HD map (three-dimensional spatial model), the transmission layer of the layer data with a high priority may be constantly the layer with high quality irrespective of the degree of congestion of the cell.

### <Configuration Example of Computer>

The above-mentioned series of processing of the communication management system 10 (200) may be executed by hardware or may be executed by software. If the series of processing is executed by software, programs that configure the software are installed in a computer. Here, the computer includes a computer incorporated in dedicated hardware, a general-purpose personal computer, for example, capable of executing various functions by installing various programs, and the like.

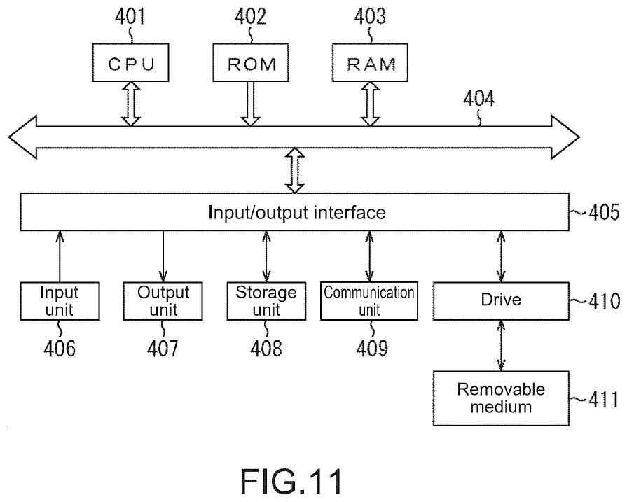

FIG. 11 is a block diagram showing a configuration example of hardware of the computer that executes the above-mentioned series of processing of the communication management system 10 (200) in accordance with the program.

In a computer 400, a central processing unit (CPU) 401, a read only memory (ROM) 402, and a random access memory (RAM) 403 are connected to one another through a bus 404.

An input/output interface 405 is also connected to the bus 404. An input unit 406, an output unit 407, a storage unit 408, a communication unit 409, and a drive 410 are connected to the input/output interface 405.

The input unit 406 includes a keyboard, a mouse, a microphone, and the like. The output unit 407 includes a display, a loudspeaker, and the like. The storage unit 408 includes a hard disk, a nonvolatile memory, and the like. The communication unit 409 includes a network interface and the like. The drive 410 drives a removable medium 411 such as a magnetic disk, an optical disc, a magneto-optical disk, and a semiconductor memory.

In the thus configured computer, the CPU 401 loads, for example, programs stored in the storage unit 408 into the RAM 403 via the input/output interface 405 and the bus 404 and executes them. In this manner, the above-mentioned series of processing is performed.

Programs executed by the computer (CPU 401) can be, for example, provided recorded on the removable medium 411 that is a package medium. Moreover, the program can be provided via a wired or wireless transmission medium such as a local area network, the Internet, and digital satellite broadcasting.

In the computer, the program can be installed into the storage unit 408 via the input/output interface 405 by mounting the removable medium 411 on the drive 410. Moreover, the program can be received by the communication unit 409 via a wired or wireless transmission medium and can be installed into the storage unit 408. Otherwise, the program can be installed into the ROM 402 or the storage unit 408 in advance.

It should be noted that the programs executed by the computer may be programs processed chronologically in the order described in the present specification or may be programs processed in parallel or at a required time, e.g., upon calling.

In the present specification, the system means a set of a plurality of components (apparatuses, modules (parts), etc.) and it does not matter whether or not all the components are contained in the same casing. Therefore, a plurality of apparatuses housed in separate casings and connected via a network and a single apparatus including a plurality of modules housed in the same casing are both considered as the system.

Embodiments of the present technology are not limited to the above-mentioned embodiments and various modifications can be made without departing from the gist of the present technology.

For example, all or some of the plurality of embodiments described above can be employed in combination.

For example, the present technology can take a cloud computing configuration in which a plurality of apparatuses shares and cooperatively processes a single function via a network.

Moreover, a plurality of apparatuses can share and execute the respective steps described above with reference to the above-mentioned flowcharts rather than executing them by a single apparatus.

In addition, if a single step is constituted by a plurality of processes, a plurality of apparatuses can share and execute the plurality of processes of the single step rather than executing them by a single apparatus.

It should be noted that the effects set forth herein are merely exemplary, not limitative, and effects other than the effects set forth herein may be provided.

It should be noted that the present technology can also take the following configurations.

(1) A communication management system, including
a plan generating unit that generates, on the basis of a state of a transmission channel on a movement route of a movable object and a priority of three-dimensional configuration view data to be used for generating a three-dimensional configuration view, a plan of a transmission timing that is a spatial timing at which the movable object transmits the three-dimensional configuration view data on the transmission channel.
   (2) The communication management system according to (1), in which
the transmission timing is configured to be a cell in which the movable object is present when transmitting the three-dimensional configuration view data.
   (3) The communication management system according to (1) or (2), in which
the plan generating unit generates the plan, in a case where the priority of the three-dimensional configuration view data is high, so that a difference between an acquisition timing and the transmission timing decreases, the acquisition timing being a spatial timing at which the movable object acquires the three-dimensional configuration view data.
   (4) The communication management system according to (3), in which
the plan generating unit generates the plan, in a case where the priority of the three-dimensional configuration view data is low, so that the transmission timing becomes a timing at which a degree of congestion representing a degree of congestion state of the transmission channel is equal to or lower than a threshold.
   (5) The communication management system according to (4), in which
the movable object is configured to transmit, in a case where the degree of congestion when acquiring the three-dimensional configuration view data is higher than the threshold, the three-dimensional configuration view data with a high priority in accordance with the transmission timing when acquiring the three-dimensional configuration view data with a high priority and transmit the three-dimensional configuration view data with a low priority when the degree of congestion becomes equal to or lower than the threshold.
   (6) The communication management system according to (5), in which
the movable object causes a storage unit to store the acquired three-dimensional configuration view data with a low priority and reads out and transmits the three-dimensional configuration view data stored in the storage unit when the degree of congestion becomes equal to or lower than the threshold.
   (7) The communication management system according to (6), in which
the movable object is configured to transmit, in a case where the degree of congestion when acquiring the three-dimensional configuration view data is equal to or lower than the threshold, in accordance with the transmission timing when acquiring the three-dimensional configuration view data.
   (8) The communication management system according to any of (1) to (7), in which
the transmission channel includes a plurality of layers with different communication quality, and
the plan generating unit is configured to generate, on the basis of the state of the transmission channel, the priority, and a cost required to secure bandwidth for each layer, plans of the layer and the transmission timing to transmit the three-dimensional configuration view data.
   (9) The communication management system according to any of (1) to (8), further including
an update unit that updates the three-dimensional configuration view on the basis of the three-dimensional configuration view data.
   (10) The communication management system according to (9), further including
a setting unit that sets the priority of the three-dimensional configuration view data on the basis of an update plan of the three-dimensional configuration view.
   (11) The communication management system according to (10), further including
an acquisition unit that acquires the update plan, in which
the setting unit is configured to set the priority on the basis of the update plan acquired by the acquisition unit.
   (12) The communication management system according to any of (1) to (11), further including
a determining unit that determines the state of the transmission channel, in which
the plan generating unit is configured to generate the plan on the basis of the state of the transmission channel determined by the determining unit and the priority.
   (13) The communication management system according to any of (1) to (12), in which
the plan generating unit is configured to generate, on the basis of the state of the transmission channel on the movement route of each of the plurality of movable objects and the priority of the three-dimensional configuration view data, the plan of each of the plurality of movable objects.
   (14) The communication management system according to (1), in which
the transmission timing is configured to be temporal and spatial timings to transmit the three-dimensional configuration view data.
   (15) A communication management method, including
by a communication management system,
generating, on the basis of a state of a transmission channel on a movement route of a movable object and a priority of three-dimensional configuration view data to be used for generating a three-dimensional configuration view, a plan of a transmission timing that is a spatial timing at which the movable object transmits the three-dimensional configuration view data on the transmission channel.
   (16) A movable object, including
a communication unit that transmits three-dimensional configuration view data in accordance with a plan of a transmission timing that is a spatial timing to transmit the three-dimensional configuration view data, the plan being generated on the basis of a state of a transmission channel on a movement route of the movable object and a priority of the three-dimensional configuration view data to be used for generating a three-dimensional configuration view.
   (17) The movable object according to (16), in which
the communication unit is configured to receive transmission plan information representing the plan from a management apparatus that generates the plan and transmit the three-dimensional configuration view data in accordance with the plan represented by the transmission plan information.
   (18) A management apparatus, including:
a plan generating unit that generates, on the basis of a state of a transmission channel on a movement route of a movable object and a priority of three-dimensional configuration view data to be used for generating a three-dimensional configuration view, a plan of a transmission timing that is a spatial timing at which a movable object transmits the three-dimensional configuration view data on the transmission channel; and
a communication unit that sends to the movable object transmission plan information representing the plan generated by the plan generating unit.
   (19) The management apparatus according to (18), in which
the plan generating unit is configured to generate, on the basis of the state of the transmission channel on the movement route of each of a plurality of the movable objects and the priority, a plan of each of the plurality of movable objects, and
the communication unit sends to each of the plurality of movable objects the transmission plan information representing the plan of the movable object.

### REFERENCE SIGNS LIST

10 communication management system
21 management apparatus
23 movable object
31 acquisition unit
32 setting unit
33 plan generating unit
35 communication unit
36 update unit
41 determining unit
55 communication unit
56 storage unit
91, 131 movement route
210 communication management system
221 management apparatus
223-1 to 223-N movable object
231 acquisition unit
232 setting unit
233 plan generating unit
235 communication unit
236 update unit
255 communication unit
291 to 293, 332, 333 movement route

1. A communication management system, comprising
a plan generating unit that generates, on a basis of a state of a transmission channel on a movement route of a movable object and a priority of three-dimensional configuration view data to be used for generating a three-dimensional configuration view, a plan of a transmission timing that is a spatial timing at which the movable object transmits the three-dimensional configuration view data on the transmission channel.

2. The communication management system according to claim 1, wherein
the transmission timing is configured to be a cell in which the movable object is present when transmitting the three-dimensional configuration view data.

3. The communication management system according to claim 1, wherein
the plan generating unit generates the plan, in a case where the priority of the three-dimensional configuration view data is high, so that a difference between an acquisition timing and the transmission timing decreases, the acquisition timing being a spatial timing at which the movable object acquires the three-dimensional configuration view data.

4. The communication management system according to claim 3, wherein
the plan generating unit generates the plan, in a case where the priority of the three-dimensional configuration view data is low, so that the transmission timing becomes a timing at which a degree of congestion representing a degree of congestion state of the transmission channel is equal to or lower than a threshold.

5. The communication management system according to claim 4, wherein
the movable object is configured to transmit, in a case where the degree of congestion when acquiring the three-dimensional configuration view data is higher than the threshold, the three-dimensional configuration view data with a high priority in accordance with the transmission timing when acquiring the three-dimensional configuration view data with a high priority and transmit the three-dimensional configuration view data with a low priority when the degree of congestion becomes equal to or lower than the threshold.

6. The communication management system according to claim 5, wherein
the movable object causes a storage unit to store the acquired three-dimensional configuration view data with a low priority and reads out and transmits the three-dimensional configuration view data stored in the storage unit when the degree of congestion becomes equal to or lower than the threshold.

7. The communication management system according to claim 6, wherein
the movable object is configured to transmit, in a case where the degree of congestion when acquiring the three-dimensional configuration view data is equal to or lower than the threshold, in accordance with the transmission timing when acquiring the three-dimensional configuration view data.

8. The communication management system according to claim 1, wherein
the transmission channel includes a plurality of layers with different communication quality, and
the plan generating unit is configured to generate, on a basis of the state of the transmission channel, the priority, and a cost required to secure bandwidth for each layer, plans of the layer and the transmission timing to transmit the three-dimensional configuration view data.

9. The communication management system according to claim 1, further comprising
an update unit that updates the three-dimensional configuration view on a basis of the three-dimensional configuration view data.

10. The communication management system according to claim 9, further comprising
a setting unit that sets the priority of the three-dimensional configuration view data on a basis of an update plan of the three-dimensional configuration view.

11. The communication management system according to claim 10, further comprising
an acquisition unit that acquires the update plan, wherein
the setting unit is configured to set the priority on a basis of the update plan acquired by the acquisition unit.

12. The communication management system according to claim 1, further comprising
a determining unit that determines the state of the transmission channel, wherein
the plan generating unit is configured to generate the plan on a basis of the state of the transmission channel determined by the determining unit and the priority.

13. The communication management system according to claim 1, wherein
the plan generating unit is configured to generate, on a basis of the state of the transmission channel on the movement route of each of the plurality of movable objects and the priority of the three-dimensional configuration view data, the plan of each of the plurality of movable objects.

14. The communication management system according to claim 1, wherein
the transmission timing is configured to be temporal and spatial timings to transmit the three-dimensional configuration view data.

15. A communication management method, comprising
by a communication management system,
generating, on a basis of a state of a transmission channel on a movement route of a movable object and a priority of three-dimensional configuration view data to be used for generating a three-dimensional configuration view, a plan of a transmission timing that is a spatial timing at which the movable object transmits the three-dimensional configuration view data on the transmission channel.

16. A movable object, comprising
a communication unit that transmits three-dimensional configuration view data in accordance with a plan of a transmission timing that is a spatial timing to transmit the three-dimensional configuration view data, the plan being generated on a basis of a state of a transmission channel on a movement route of the movable object and a priority of the three-dimensional configuration view data to be used for generating a three-dimensional configuration view.

17. The movable object according to claim 16, wherein
the communication unit is configured to receive transmission plan information representing the plan from a management apparatus that generates the plan and transmit the three-dimensional configuration view data in accordance with the plan represented by the transmission plan information.

18. A management apparatus, comprising:
a plan generating unit that generates, on a basis of a state of a transmission channel on a movement route of a movable object and a priority of three-dimensional configuration view data to be used for generating a three-dimensional configuration view, a plan of a transmission timing that is a spatial timing at which a movable object transmits the three-dimensional configuration view data on the transmission channel; and
a communication unit that sends to the movable object transmission plan information representing the plan generated by the plan generating unit.

19. The management apparatus according to claim 18, wherein
the plan generating unit is configured to generate, on a basis of the state of the transmission channel on the movement route of each of a plurality of the movable objects and the priority, a plan of each of the plurality of movable objects, and
the communication unit sends to each of the plurality of movable objects the transmission plan information representing the plan of the movable object.
